(19) United States
(12) Patent Application Publication
(10) Pub. No.: US 2010/0092907 A1
(43) Pub. Date: Apr. 15, 2010

(54) Method And System For Deriving A Common Coordinate System For Virtual Orthodontic Brackets

(75) Inventor: Peter G. Knopp, Pleasanton, CA (US)

Correspondence Address: Theodore P. Lopez;Klein, O'Neill & Singh, LLP, Suite 204, 43 Corporate Park, Irvine, CA, 92606, US

(73) Assignee: Align Technology, Inc., Santa Clara, CA (US)

(21) Appl. No.: 12/249,536

(22) Filed: Oct. 10, 2008

(51) Int. Cl. A61C 7/00; G06F 19/00

(52) U.S. Cl. 433/24; 700/117

(57) ABSTRACT

Method and apparatus including obtaining digital representations of two or more dental appliances, determining a common base coordinate parameter for the two or more dental appliances, orientating the respective digital representations of the two or more dental appliances in accordance with the common base coordinate parameter, aligning the digital representations of the two or more dental appliances based on one or more characteristics associated with each of the two or more dental appliances, and storing the digital representations of the two or more dental appliances oriented to based on the common base coordinate parameter are disclosed.

### BACKGROUND

The present disclosure relates generally to the field of orthodontics. More specifically, the present disclosure relates to the field of determining a common coordinate system for orthodontic brackets made by different manufacturers for interchangeability in a digital orthodontic model.

The main objective of orthodontics is to move a patient's teeth into an optimal final occlusion, or a position in which the teeth function optimally and are aesthetically pleasing to the patient. Conventionally, appliances such as braces, which are a bracket and arch wire system, are applied to the teeth of the patient by an orthodontist or other qualified dental professional. The brackets in the braces system are mounted on the surface of the teeth of a patient and the arch wire couples all the brackets on the same jaw to one another. The arch wire is incrementally tightened over time during office visits to the treating professional. Each reactive adjustment to tighten the wire exerts a force on the teeth, gradually moving them generally toward a desired final position.

With the development of digital virtual representations, the field of virtual orthodontics is rapidly becoming a more commonly used tool for corrective dentistry. One of the challenges in orthodontics is determining a satisfactory final occlusion, or the system of the final positions and orientations of all teeth, prior to the commencement of treatment. In order to present as many options as possible to a patient and treating dental or orthodontic professional, it is preferable to have a method of interchanging different brackets made by different manufacturers, in a digital virtual model of a treatment process. However, since different manufacturers design and manufacture brackets with different specifications, interchangeability between different brackets for patient treatment may be difficult, thus potentially limiting the treatment options, depending upon the orthodontist's preference or availability of certain types of brackets from a given manufacturer, for example.

### SUMMARY

In view of the foregoing, in one aspect, there is provided a method obtaining digital representations of two or more dental appliances, determining a common base coordinate parameter for the two or more dental appliances, orientating the respective digital representations of the two or more dental appliances in accordance with the common base coordinate parameter, aligning the digital representations of the two or more dental appliances based on one or more characteristics associated with each of the two or more dental appliances, and storing the digital representations of the two or more dental appliances oriented based on the common base coordinate parameter.

In a further aspect, a computer program product in another aspect may include a medium readable by a computer, the computer readable medium having computer program code adapted to: obtain digital representations of two or more dental appliances, determine a common base coordinate parameter for the two or more dental appliances, orient the respective digital representations of the two or more dental appliances in accordance with the common base coordinate parameter, align the digital representations of the two or more dental appliances based on one or more characteristics associated with each of the two or more dental appliances, and store the digital representations of the two or more dental appliances oriented based on the common base coordinate parameter.

### BRIEF DESCRIPTION OF THE DRAWINGS

FIG. 1 is a diagram of the lower jaw and teeth of a patient's mouth;

FIG. 2A is an example of two brackets shown in their own software spaces;

FIG. 2B is an example of the same two brackets shown in FIG. 2A, displayed in the same software space;

FIG. 2C is an example of the same two brackets shown in FIGS. 2A and 2B, rotated and overlaid to have a shared coordinate system;

FIG. 3 illustrates an example of brackets attached to different teeth of a patient for use in one or more embodiments of the present disclosure;

FIG. 4 is a flow chart illustrating a process for determining a common coordinate system for orthodontic brackets in one aspect;

FIG. 5 is a flow chart illustrating a process for determining a common coordinate system for orthodontic brackets in accordance with another aspect;

FIG. 6 is a flow chart illustrating a process for determining a common coordinate system for orthodontic brackets in accordance with still another aspect of the present disclosure; and

FIG. 7 is a flow chart illustrating a process of virtual orthodontic treatment in one aspect of the present disclosure.

### DETAILED DESCRIPTION

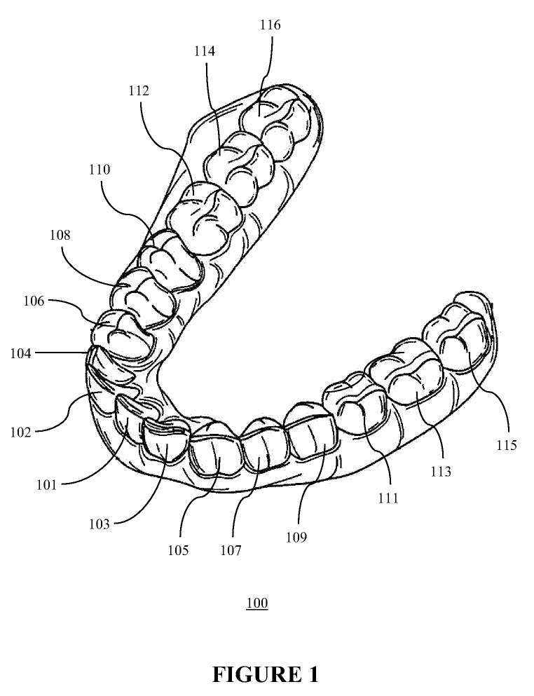

FIG. 1 is a diagram of the lower jaw and teeth of a patient's mouth. Referring to FIG. 1, the lower jaw 100 of a patient may include teeth such as the left central incisor 101, the right central incisor 102, the left lateral incisor 103, the right lateral incisor 104, the left cuspid or canine 105, the right cuspid 106, the left first bicuspid 107, the right first bicuspid 108, the left second bicuspid 109, the right second bicuspid 110, the left first molar 111, the right first molar 112, the left second molar 113, the right second molar 114, the left third molar or wisdom tooth 115, and the right third molar or wisdom tooth 116. The upper jaw of a patient may have a similar set of incisors, cuspids, bicuspids, and molars. The relationship between the individual teeth of the jaw 100 and the relationship between the sets of teeth on the upper and lower jaws 100 are used to determine the corrective measures needed in a chosen orthodontic procedure. Different types of malocclusion, a non-optimal positioning of a patient's teeth, may include, among others, overbite, also known as class II malocclusion, underbite, also known as class III malocclusion, overjet, and diastema. Individual tooth positions may also affect the type of chosen orthodontic procedure, such as crooked or rotated teeth.

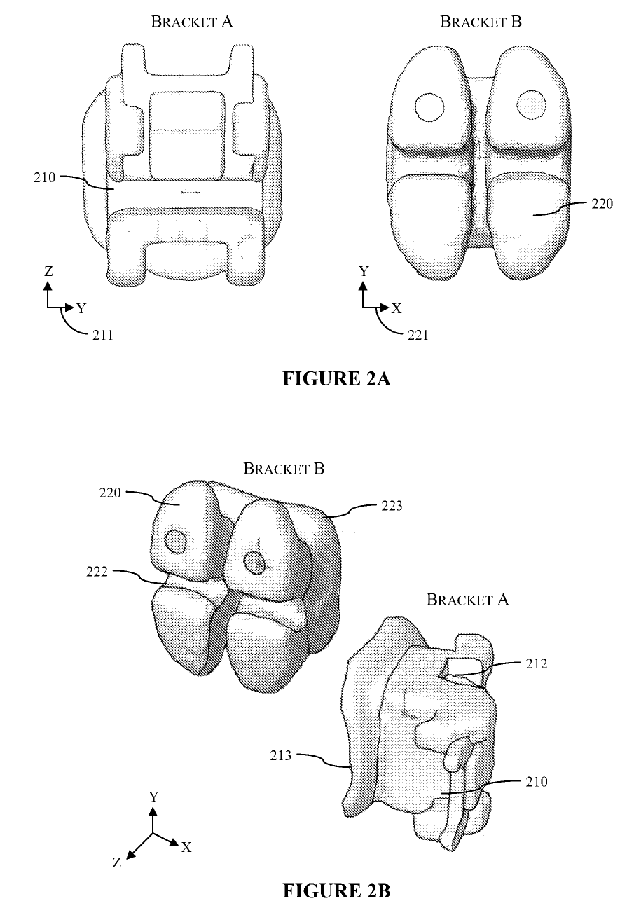

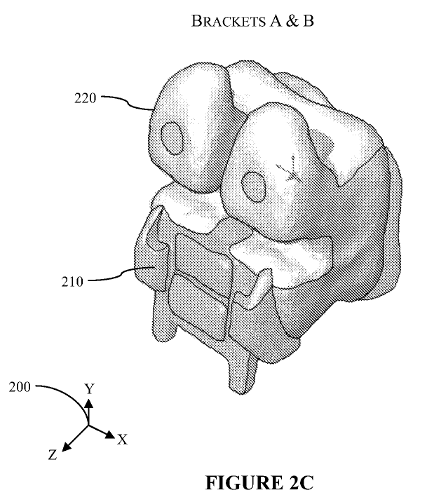

FIG. 2A is an example of two brackets shown in their own software spaces. Referring to FIG. 2A, two examples of brackets meant to be mounted on the same tooth but made by different manufacturers, are shown. The virtual representation of Bracket A 210 is shown in the coordinate system 211 provided by the Bracket A manufacturer. The virtual representation of Bracket B 220 is shown in the coordinate system 221 provided by the Bracket B manufacturer.

FIG. 2B is an example of the same two brackets shown in FIG. 2A, displayed in the same software space. Referring to FIG. 2B, while keeping each bracket in line with the coordinate system provided by the manufacturer, Bracket A 210 and Bracket B 220 are displayed in the same software space. As shown in FIG. 2B, the surface of the bracket to be mounted on the tooth of a patient 213 of Bracket A 210 is not at a consistent coordinate direction in comparison to the surface to be mounted on the tooth of a patient 223 of Bracket B 220 when based upon the chosen coordinate systems of each different manufacturer. In order for Bracket A 210 and Bracket B 220 to be interchangeable in a digital virtual representation, the brackets must be rotated and positioned in such a way as to have a common coordinate system with respect to a patient's tooth.

Still referring to FIG. 2B, not only is the surface of the bracket to be mounted on the surface of the patient's tooth not in the same direction for Bracket A 210 and Bracket B 220, but the bracket slots 212 222, which may be used to hold the arch wire in place, for each respective bracket are also not oriented in the same direction. The slot 212 for Bracket A 210, when displayed based upon the coordinate system provided by the manufacturer is generally in the Y direction. The slot 222 for Bracket B 220, when displayed based upon the coordinate system provided by the manufacturer is generally in the X direction.

FIG. 2C is an example of the same two brackets shown in FIGS. 2A and 2B, rotated and overlaid to have a shared coordinate system. Referring to FIGS. 2B and 2C, in order to determine a common coordinate system between Bracket A 210 and Bracket B 220, a common directionality and common focal characteristic or feature must be determined. To determine the common directionality of the two brackets, the direction of the surface of the bracket to be mounted on the tooth is used. The directionality of this surface is standard for all manufactured orthodontic brackets, as it must be lined up with the surface of the tooth. A common focal feature between brackets can be the bracket slot. The bracket slot is the portion of the bracket in which the arch wire is coupled and held in position.

Still referring to FIG. 2C, when the directionality of the surface of the bracket to be mounted to the surface of the patient's tooth is the same for both Bracket A 210 and Bracket B 220, and the slot 212 for Bracket A 210 and the slot 222 for Bracket B 220 are lined up, the two brackets can be overlaid on top of one another, as seen in FIG. 2C. Once the brackets are lined up, a new coordinate system 200 can be determined based upon the common directionality and position of both brackets. Once a new coordinate system 200 that can be applied to both Bracket A 210 and Bracket B 220 has been determined, the brackets may be easily interchanged in the virtual model without changing the nature of the orthodontic procedure. This process may be applied to any number of different brackets, using any number of different focal characteristics and features as base comparison points. Once the common coordinate system 200 between all bracket choices has been determined, the brackets may be changed at will by the treating professional in the virtual model in order to satisfy the preference of the patient and treating professional.

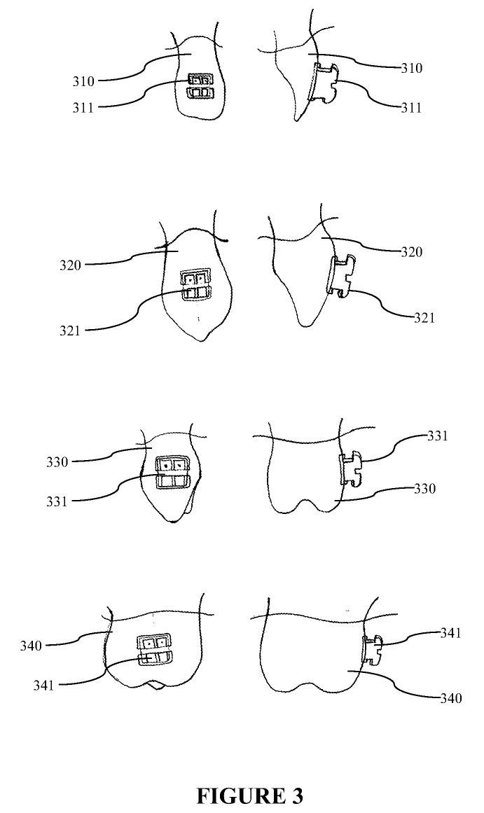

FIG. 3 illustrates an example of brackets attached to different teeth of a patient for use in one or more embodiments of the present disclosure. Referring to FIGS. 1 and 3, in one embodiment of the present disclosure, brackets 311, 321, 331, 341 for orthodontic treatment procedures may be attached to the incisors 310, canine teeth 320, bicuspids 330, and molars 340. The bracket 321 attached to a canine tooth 320, for example, is attached to the buccal or lingual surface of the canine tooth 320 by use of a dental cement, or substantial equivalent, in a position determined by identifiable referents on the patient's tooth and the desired final position and geometry of the tooth. Similarly, the brackets may be attached to the central and lateral incisors 310, bicuspids 330, and molars 340. The brackets are coupled to an arch wire that is tightened to apply directional force on the teeth of a patient in an effort to shift the position or rotational angle of the teeth. The teeth are shifted in such a way to result a desired final occlusion, or positioning, of the teeth.

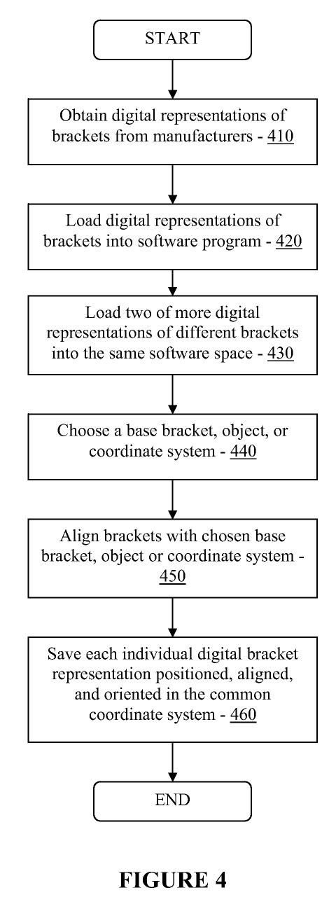

FIG. 4 is a flow chart illustrating a process for determining a common coordinate system for orthodontic brackets, where the digital representation of the brackets is provided by the manufacturer in accordance with one aspect of the present disclosure. Referring to FIG. 4, in one embodiment, once the digital representations of the brackets is procured from each manufacturer 410, the files are loaded into a software program capable of reading the file formats 420. In another embodiment, the file formats for the digital representations of each bracket provided by the manufacturer do not need to be the same file format.

The software program may be capable of reading, among others, file types including stereolithography CAD (STL) files, initial graphics exchange specification (IGES) files, standard for the exchange of product model data (STEP) files, and other computer assisted design (CAD) files. Two or more digital representations of brackets files are loaded into the same software space at the same time 430, or are opened first in their own software space before being loaded into the common space. One of the two or more digital representations of brackets is chosen as the base bracket 440 for uses of selecting a common coordinate system. Alternatively, a separate object or coordinate system may be chosen for determining the base orientation and position for selecting the common coordinate system.

Referring still to FIG. 4, once the digital representations of the brackets are in the same coordinate space and a base coordinate system or base bracket has been determined, the brackets are aligned to the chosen base coordinate system or bracket using known common dimensions or features as a basis 450. One or more common dimensions or features may be used for the alignment process to the base coordinate system. An example of a feature generally common to all brackets includes, but is not limited to, bracket slots, or the slot wherein the arch wire is coupled to the bracket and held in position. Within some level of tolerance, most if not all manufacturers' bracket slots are, typically, either approximately 0.018 inches (0.46 mm) or approximately 0.022 inches (0.56 mm) in the occlusogingival direction and slot lengths are typically specified so that the midpoint is easily determined. Often times, features and points of interest of the digital representation of a bracket are specified in the manufacturer provided digital representations of the brackets. In another embodiment of the present disclosure, each bracket is overlaid upon one another once a basis coordinate system is determined in order to verify the alignment of the brackets, as seen in FIG. 2C.

Still referring to FIG. 4, once all the digital representations of the brackets are commonly aligned, positioned, and oriented, each individual bracket digital representation file is individually saved with its newly defined position and orientation 460. At this point, the digital representations of each bracket are now all orientated on a common coordinate system, thus allowing a treating professional to evaluate options by choosing between different brackets in the orthodontic virtual model. In yet another embodiment, once a set of brackets for the teeth for one side of a patent's mouth has been positioned and oriented to a common coordinate system, the brackets may be mirrored relative to a reference plane or surface to determine the position and orientation and common coordinate system for the equivalent contralateral brackets. Alternatively, the same processes as depicted above may be applied to each individual bracket to be used in the orthodontic treatment process.

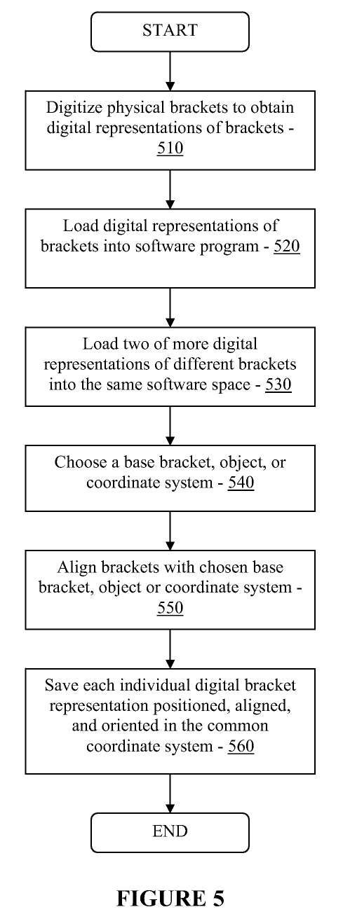

FIG. 5 is a flow chart illustrating a process of determining a common coordinate system for orthodontic brackets, where the digital representation of the brackets is not provided by the manufacturer, in accordance with another aspect of the present disclosure. Before any virtual orthodontic treatment is possible, digital representations of the orthodontic apparatus' is necessary. In the case where a traditional bracket and arch wire braces orthodontic treatment system is desired, digital representations of the orthodontic brackets is needed. These digital representations may be provided by the manufacturer, however, in the case that they are not, digital representations of the brackets must be created based upon the physical brackets. This process is known as digitization. Digitization may be performed in several alternate manners, including, but not limited to, the processes of computer tomography, acoustic imaging, surface tracing, and destructive scanning. Digitization may be performed either directly or indirectly. That is, a direct digitization process is the digitization of the body, in this case a bracket, itself, whereas indirect digitization is the digitization of an impression or mold of the body.

Referring to FIG. 5, in one embodiment of the present disclosure, digital representations of orthodontic brackets are generated through a process of direct digitization of the physical brackets or indirect digitization of impressions of the brackets 510. The digitized bracket files are loaded into a software program capable of reading the file formats 520. In another embodiment, the file formats for the digital representations of each bracket do not need to be the same file format. The software program may be capable of reading, among others, file types including STL, IGES, STEP, and other CAD files. Two or more digital representations of brackets files are loaded into the same software space at the same time 530, or are opened first in their own software space before being loaded into the common space. One of the two or more digital representations of brackets is chosen as the base bracket 540 for uses of selecting a common coordinate system. Alternatively, a separate object or coordinate system may be chosen for determining the base orientation and position for selecting the common coordinate system.

Once the digital representations of the brackets are in the same coordinate space and a base coordinate system or base bracket has been determined, the brackets are aligned to the chosen base coordinate system or bracket using known common dimensions or features as a basis 550, and as discussed above in conjunction with step 450, FIG. 4.

Still referring to FIG. 5, once all the digital representations of the brackets are commonly aligned, positioned, and oriented, each individual bracket digital representation file is individually saved with its newly defined position and orientation 560. Thus, the digital representations of each bracket are all orientated on a common coordinate system, thus permitting a treating professional to evaluate options by selecting from different brackets in the orthodontic virtual model. In yet a further embodiment, once a set of brackets for the teeth for one side of a patent's mouth has been positioned and oriented to a common coordinate system, the brackets may be mirrored relative to a reference plane or surface to determine the position and orientation and common coordinate system for the equivalent contralateral brackets. Alternatively, the same processes as depicted above may be applied to each individual bracket to be used in the orthodontic treatment process.

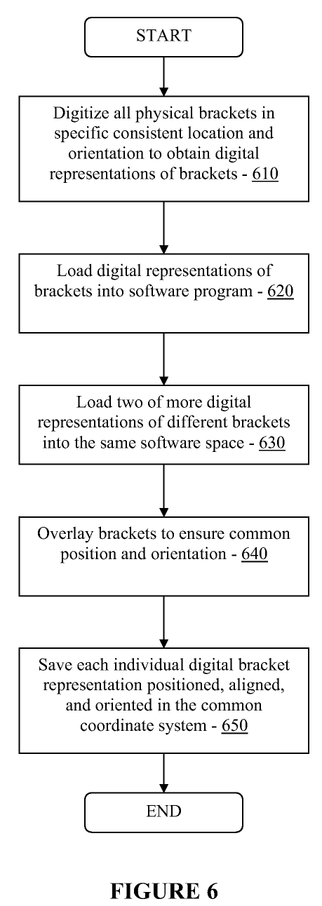

FIG. 6 is a flow chart illustrating a process for determining a common coordinate system for orthodontic brackets, where the digital representation of the brackets is not provided by the manufacturer in accordance with still another aspect of the present disclosure. Referring to FIG. 6, in one embodiment of the present disclosure, during the process of digitizing the brackets to create digital representations of the brackets, the physical brackets are held in place in such a manner so as a common feature, such as the arch wire slot of a bracket, is held in the same special location and orientation 610. This process allows for the digital representations of the brackets to already have a common coordinate system and reference once the digitization process is complete.

One feature to be used as a basis for the digitization alignment includes the arch wire slot of a bracket, due to the fact that it is the most consistent geometry with the greatest dimensional similarity among brackets made by different manufacturers. Once the brackets have been digitized, the digital representations of the digitized bracket files are loaded into a software program capable of reading the file formats 620. In another embodiment, the file formats for the digital representations of each bracket do not need to be the same file format. The software program may be capable of reading, among others, file types including STL, IGES, STEP, and other CAD files.

Referring again to FIG. 6, in one aspect, two or more digital representations of brackets files are loaded into the same software space at the same time 630, or are opened first in their own software space before being loaded into the common space. In yet another embodiment of the present disclosure, the two or more digital representations of brackets are overlaid upon one another 640 to ensure common position and orientation was achieved during the digitization process, and if necessary, the digital representations may be repositioned in the software space to correctly align the feature characteristics in order to create a common coordinate system. Once it is confirmed that all the digital representations of the brackets are commonly aligned, positioned, and oriented, each individual bracket digital representation file is individually saved with the common position and orientation 650.

In this manner, the digital representations of each bracket are orientated on a common coordinate system, thus allowing a treating professional to evaluate options by choosing different brackets in the orthodontic virtual model. In yet another embodiment, once a set of brackets for the teeth for one side of a patent's mouth has been positioned and oriented to a common coordinate system, the brackets may be mirrored relative to a reference plane or surface to determine the position and orientation and common coordinate system for the equivalent contralateral brackets. Alternatively, the same processes as depicted above may be applied to each individual bracket to be used in the orthodontic treatment process.

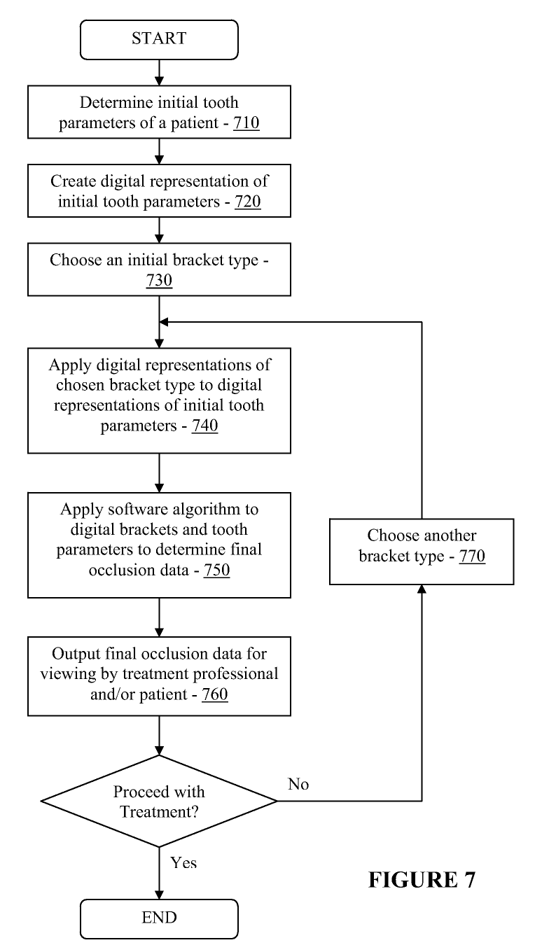

FIG. 7 is a flow chart illustrating a process of virtual orthodontic treatment in accordance with a further aspect. Referring to FIG. 7, in one embodiment of the present disclosure, determining initial tooth parameters 710 may be done by any number of methods, including, but not limited to, dental impressions, intraoral scanning, X-ray, or magnetic resonance imaging (MRI). A digital representation of the initial tooth parameters is created 720. The digital representation articulates, among others, the position and geometry of each individual tooth of a patient. Based on doctor experience and patient preference, among others, a treating professional chooses an initial bracket type set for possible use in the orthodontic treatment 730.

Digital representations of initially chosen brackets are applied to the digital representation of the initial tooth parameters 740. The digital representations of the brackets may be obtained directly from the manufacturer of the chosen brackets, or may be directly or indirectly digitized through a choice of digitization processes including, but not limited to, computer tomography, acoustic imaging, surface tracing, or destructive scanning. A software algorithm is used to determine a final occlusion based on the chosen bracket type and treatment type 750 and an output of the final occlusion is displayed 760 for viewing by the patient and treating professional.

Still referring to FIG. 7, in yet another embodiment of the present disclosure, the treating professional may have the option of replacing the initially chosen bracket type with a second bracket type 770. In order for the second bracket type to be substituted for the initial bracket type with minimal extra modifications and adjustments, the digital representations of the second bracket type and the first bracket type must have a common coordinate system. To obtain digital representations of bracket types with common coordinate systems, a number of methods may be employed, including, but not limited to, the methods described within this disclosure.

Once the initial bracket type has been replaced with the second bracket type, and the second bracket type has been applied to the initial teeth parameters 740, the software algorithm is once again used to determine a final occlusion 750, now based on the new bracket type. An output of the final occlusion is displayed 760 for viewing by the patient and treating professional. The patient and treating professional may then decide which, if any, of the final results they prefer. The treating professional may then proceed with the treatment, using the final occlusion output information as a basis for the physical treatment, or the treating professional may choose yet another bracket type to substitute into the virtual model for yet another final occlusion output option. This process may be repeated as often as necessary until the treating professional and the patient decide upon a preferred method of orthodontic treatment.

Accordingly, in one aspect, in order for a treating professional to determine a final occlusion, or final positioning of teeth, a virtual model of the orthodontic process may be used. The model may include a digital representation of the initial parameters of a patient's teeth, and then apply digital representations of a bracket and wire braces system to the digital representation of the patient's teeth. The digital teeth and braces system is applied to a software algorithm, which may output the final occlusion of the patient's teeth based on the input parameters.

In one embodiment of the present disclosure, an option for optimizing the process of virtual orthodontics is presented. This includes, among others, the determination of a common coordinate system of different manufacturer brackets. In a virtual orthodontics model, the type of bracket may affect the final occlusion output data parameters. Therefore, it would be preferable for an orthodontic or dental treating professional to have the option of interchanging different brackets types in the orthodontic model in an effort to determine the best and most preferable final occlusion of the patient's teeth. However, without a common coordinate system among the different manufacturer bracket types, it may take a treating professional an undue amount of modification and adjustment to interchange bracket types in a digital model.

The present disclosure presents, among others, a method for determining a common coordinate system between different brackets manufactured by different manufacturers.

Accordingly, a method in one aspect includes obtaining digital representations of two or more dental appliances, determining a common base coordinate parameter for the two or more dental appliances, orientating the respective digital representations of the two or more dental appliances in accordance with the common base coordinate parameter, aligning the digital representations of the two or more dental appliances based on one or more characteristics associated with each of the two or more dental appliances, and storing the digital representations of the two or more dental appliances oriented based on the common base coordinate parameter.

In one aspect, obtaining the digital representations of the two or more dental appliances may include retrieving one or more computer software files associated with the digital representations of each of the two or more dental appliances.

Further, obtaining the digital representations of the two or more dental appliances may include digitizing the two or more dental appliances, where digitizing may include one or more of computer tomography, acoustic imaging, surface tracing, or destructive scanning.

Also, in a further aspect, digitizing the two or more dental appliances may include direct digitization or indirect digitization, where direct digitization includes digitizing the physical configuration of the two or more dental appliances, while indirect digitization includes digitizing one or more of an impression or mold of the dental appliance physical configuration.

In still another aspect, aligning may include analysis of a predefined geometric parameter for each of the two or more dental appliances, where the predefined geometric parameter may include an arch wire slot. The analysis in one aspect, may include spatially aligning the respective predefined geometric parameter for two or more of the dental appliances.

In yet another aspect, the method may include overlaying the digital representations of the two or more dental appliances, which may include orthodontic brackets.

A computer program product in another aspect may include a medium readable by a computer, the computer readable medium having computer program code adapted to: obtain digital representations of two or more dental appliances, determine a common base coordinate parameter for the two or more dental appliances, orient the respective digital representations of the two or more dental appliances in accordance with the common base coordinate parameter, align the digital representations of the two or more dental appliances based on one or more characteristics associated with each of the two or more dental appliances, and store the digital representations of the two or more dental appliances oriented based on the common base coordinate parameter.

In one aspect, the executable computer program code in the computer readable medium may be adapted to retrieve one or more computer software files associated with the digital representations of each of the two or more dental appliances.

The executable computer program code in the computer readable medium may be adapted to digitize the two or more dental appliances.

In a further aspect, the executable computer program code in the computer readable medium may be adapted to include one or more of computer tomography, acoustic imaging, surface tracing, or destructive scanning.

The executable computer program code in the computer readable medium may be adapted to execute direct digitization or indirect digitization.

The executable computer program code in the computer readable medium may be adapted to analyze a predefined geometric parameter for each of the two or more dental appliances.

In still another aspect, the executable computer program code in the computer readable medium may be adapted to spatially align the respective predefined geometric parameter for two or more of the dental appliances.

In yet still another aspect, the executable computer program code in the computer readable medium may be adapted to overlay the digital representations of the two or more dental appliances, which may include orthodontic brackets.

Various other modifications and alterations in the structure and method of operation of this disclosure will be apparent to those skilled in the art without departing from the scope and spirit of the disclosure. Although the disclosure has been described in connection with specific embodiments, it should be understood that the disclosure as claimed should not be unduly limited to such specific embodiments. It is intended that the following claims define the scope of the present disclosure and that structures and methods within the scope of these claims and their equivalents be covered thereby.

What is claimed is:

1. A method, comprising:
obtaining digital representations of two or more dental appliances;
determining a common base coordinate parameter for the two or more dental appliances;
orientating the respective digital representations of the two or more dental appliances in accordance with the common base coordinate parameter;
aligning the digital representations of the two or more dental appliances based on one or more characteristics associated with each of the two or more dental appliances; and
storing the digital representations of the two or more dental appliances oriented based on the common base coordinate parameter.

2. The method of claim 1, wherein obtaining the digital representations of the two or more dental appliances includes retrieving one or more computer software files associated with the digital representations of each of the two or more dental appliances.

3. The method of claim 1, wherein obtaining the digital representations of the two or more dental appliances includes digitizing the two or more dental appliances.

4. The method of claim 3 wherein digitizing includes one or more of computer tomography, acoustic imaging, surface tracing, or destructive scanning.

5. The method of claim 3 wherein digitizing the two or more dental appliances includes direct digitization or indirect digitization.

6. The method of claim 5 wherein direct digitization includes digitizing the physical configuration of the two or more dental appliances.

7. The method of claim 5 wherein indirect digitization includes digitizing one or more of an impression or mold of the dental appliance physical configuration.

8. The method of claim 1, wherein aligning includes analysis of a predefined geometric parameter for each of the two or more dental appliances.

9. The method of claim 8 wherein the predefined geometric parameter includes an arch wire slot.

10. The method of claim 8 wherein the analysis includes spatially aligning the respective predefined geometric parameter for two or more of the dental appliances.

11. The method of claim 1 including overlaying the digital representations of the two or more dental appliances.

12. The method of claim 1 wherein the two or more dental appliances includes orthodontic brackets.

13. A computer program product, comprising:
a medium readable by a computer, the computer readable medium having computer program code adapted to:
obtain digital representations of two or more dental appliances;
determine a common base coordinate parameter for the two or more dental appliances;
orient the respective digital representations of the two or more dental appliances in accordance with the common base coordinate parameter;
align the digital representations of the two or more dental appliances based on one or more characteristics associated with each of the two or more dental appliances; and
store the digital representations of the two or more dental appliances oriented to based on the common base coordinate parameter.

14. The computer program product of claim 13, wherein the executable computer program code in the computer readable medium is adapted to retrieve one or more computer software files associated with the digital representations of each of the two or more dental appliances.

15. The computer program product of claim 13, wherein the executable computer program code in the computer readable medium is adapted to digitize the two or more dental appliances.

16. The computer program product of claim 15 wherein the executable computer program code in the computer readable medium is adapted to include one or more of computer tomography, acoustic imaging, surface tracing, or destructive scanning.

17. The computer program product of claim 15 wherein the executable computer program code in the computer readable medium is adapted to execute direct digitization or indirect digitization.

18. The computer program product of claim 17 wherein direct digitization includes digitizing the physical configuration of the two or more dental appliances.

19. The computer program product of claim 17 wherein indirect digitization includes digitizing one or more of an impression or mold of the dental appliance physical configuration.

20. The computer program product of claim 13, wherein the executable computer program code in the computer readable medium is adapted to analyze a predefined geometric parameter for each of the two or more dental appliances.

21. The computer program product of claim 20 wherein the predefined geometric parameter includes an arch wire slot.

22. The computer program product of claim 20 wherein the executable computer program code in the computer readable medium is adapted to spatially align the respective predefined geometric parameter for two or more of the dental appliances.

23. The method of claim 13 wherein the executable computer program code in the computer readable medium is adapted to overlay the digital representations of the two or more dental appliances.

24. The computer program product of claim 13 wherein the two or more dental appliances includes orthodontic brackets.
